(19) United States
(12) Patent Application Publication
(10) Pub. No.: US 2023/0088975 A1
(43) Pub. Date: Mar. 23, 2023

(54) RETURNING METHOD, CONTROLLER, UNMANNED AERIAL VEHICLE AND STORAGE MEDIUM

(71) Applicant: AUTEL ROBOTICS CO., LTD., Shenzhen (CN)

(72) Inventor: Minghua LU, Shenzhen (CN)

(21) Appl. No.: 18/058,404

(22) Filed: Nov. 23, 2022

Related U.S. Application Data
(63) Continuation of application No. PCT/CN2021/094625, filed on May 19, 2021.

(30) Foreign Application Priority Data
May 26, 2020 (CN) 202010455130.X

(51) Int. Cl. G05D 1/06; G05D 1/04; G05D 1/10; B64C 39/02

(52) U.S. Cl. CPC G05D 1/0676; G05D 1/042; G05D 1/101; B64C 39/024; B64C 2201/141; B64C 2201/18

(57) ABSTRACT

Embodiments of the present invention are a returning method, a controller, an unmanned aerial vehicle and a storage medium. The returning method includes: first obtaining a flight mode of an unmanned aerial vehicle, and determining a returning mode of the unmanned aerial vehicle according to the flight mode; then controlling, according to the returning mode, the unmanned aerial vehicle to return from a current position to a landing point, and determining, in a returning process, whether to switch the returning mode of the unmanned aerial vehicle according to a flight speed of the unmanned aerial vehicle; returning according to a switched returning mode when it is determined to switch the returning mode of the unmanned aerial vehicle; and keeping the current returning mode and returning when it is determined not to switch the returning mode of the unmanned aerial vehicle.

### CROSS-REFERENCE TO RELATED APPLICATIONS

The present application is a continuation of International Application No. PCT/CN2021/094625, filed on May 19, 2021, which claims priority to Chinese Patent Application No. 202010455130X, filed on May 26, 2020, which is incorporated herein by reference in its entirety.

### TECHNICAL FIELD

The present invention relates to the field of unmanned aerial vehicles, and in particular, to a returning method, a controller, an unmanned aerial vehicle and a storage medium.

### BACKGROUND

With the development of social science and technology, people see unmanned aerial vehicles in more and more occasions. An unmanned aerial vehicle is an unmanned aircraft that controls a flight attitude by using a radio remote control device and a built-in program, which has been well applied in more and more fields.

Generally, a returning function is disposed in the unmanned aerial vehicle. After the unmanned aerial vehicle flies away from a take-off point, a returning task is triggered manually or automatically, so that the unmanned aerial vehicle automatically returns and lands to a landing point that a user expects according to a specific working logic. However, a current returning mode of the unmanned aerial vehicle is single, resulting in low returning efficiency of the unmanned aerial vehicle, which affects the user experience.

### SUMMARY

Embodiments of the present invention resolve at least one of the above problems to some extent. To this end, the present invention provides a returning method, a controller, an unmanned aerial vehicle and a storage medium, so that different modes are switched for returning in a returning process, thereby improving the returning efficiency, and improving the user experience.

According to a first aspect, an embodiment of the present invention provides a returning method, applied to an unmanned aerial vehicle, where the unmanned aerial vehicle includes at least two returning modes, and the method includes:

obtaining a flight mode of the unmanned aerial vehicle, and determining a returning mode of the unmanned aerial vehicle according to the flight mode; and

controlling, according to the returning mode of the unmanned aerial vehicle, the unmanned aerial vehicle to return from a current position to a landing point, and switching, in a returning process, the returning mode of the unmanned aerial vehicle in real time according to a flight speed of the unmanned aerial vehicle.

In some embodiments, the returning mode includes a first mode and a second mode, and when the returning mode of the unmanned aerial vehicle is the first mode, the controlling, according to the returning mode of the unmanned aerial vehicle, the unmanned aerial vehicle to return from a current position to a landing point, and determining, in a returning process, whether to switch the returning mode of the unmanned aerial vehicle according to a flight speed of the unmanned aerial vehicle includes:

controlling the unmanned aerial vehicle to fly from the current position to a first position in the first mode;

controlling the unmanned aerial vehicle to land from the first position, and controlling the unmanned aerial vehicle to decelerate in a landing process; and

switching the returning mode to the second mode when the flight speed of the unmanned aerial vehicle is less than or equal to a first preset speed.

In some embodiments, when the returning mode of the unmanned aerial vehicle is the second mode, the controlling, according to the returning mode of the unmanned aerial vehicle, the unmanned aerial vehicle to return from a current position to a landing point, and determining, in a returning process, whether to switch the returning mode of the unmanned aerial vehicle according to a flight speed of the unmanned aerial vehicle includes:

controlling the unmanned aerial vehicle to accelerate when a distance of the unmanned aerial vehicle from the landing point is greater than a first preset distance or an altitude of the unmanned aerial vehicle is greater than a first preset altitude; and switching the returning mode to the first mode when the flight speed of the unmanned aerial vehicle is greater than a second preset speed.

In some embodiments, the controlling the unmanned aerial vehicle to fly from the current position to a first position in the first mode includes:

determining a first circling center position according to the current position, and obtaining a circling radius;

determining a circling cut out point according to the first circling center position, the circling radius and a second preset altitude;

controlling the unmanned aerial vehicle to fly from the current position to the circling cut out point;

determining a second circling center position and a circling entry point according to the landing point;

controlling the unmanned aerial vehicle to fly from the circling cut out point to the circling entry point;

determining the first position according to the second circling center position, the circling radius and a third preset altitude; and

controlling the unmanned aerial vehicle to fly from the circling entry point to the first position.

In some embodiments, the controlling the unmanned aerial vehicle to fly from the circling cut out point to the circling entry point includes:

obtaining information about an obstacle at the current position of the unmanned aerial vehicle; and

controlling, according to the information about the obstacle and the current position, the unmanned aerial vehicle to fly over the obstacle.

In some embodiments, the information about the obstacle includes an altitude of the obstacle, and the controlling, according to the information about the obstacle and the current position of the unmanned aerial vehicle, the unmanned aerial vehicle to fly over the obstacle includes:

determining a first altitude according to the altitude of the obstacle, where the first altitude is higher than the altitude of the obstacle;

controlling the unmanned aerial vehicle to fly from the current position to the first altitude; and

controlling the unmanned aerial vehicle to keep flying at the first altitude, to cause the unmanned aerial vehicle to fly over the obstacle.

In some embodiments, the controlling, according to the returning mode of the unmanned aerial vehicle, the unmanned aerial vehicle to return from a current position to a landing point, and determining, in a returning process, whether to switch the returning mode of the unmanned aerial vehicle according to a flight speed of the unmanned aerial vehicle further includes:

controlling the unmanned aerial vehicle to land to the landing point in the second mode when the distance of the unmanned aerial vehicle from the landing point is less than the first preset distance and the altitude of the unmanned aerial vehicle is less than the first preset altitude.

In some embodiments, the controlling the unmanned aerial vehicle to land to the landing point in the second mode includes:

determining whether the distance of the unmanned aerial vehicle from the landing point is less than or equal to a second preset distance;

controlling, when the distance of the unmanned aerial vehicle from the landing point when less than or equal to the second preset distance, the unmanned aerial vehicle to perform a landing operation; and

determining, when the distance of the unmanned aerial vehicle from the landing point is greater than the second preset distance, a second altitude according to the distance of the unmanned aerial vehicle from the landing point, and controlling the unmanned aerial vehicle to fly from the current position to the second altitude and land from the second altitude to the landing point.

In some embodiments, the landing operation includes:

controlling the unmanned aerial vehicle to vertically land from the current position.

According to a second aspect, an embodiment of the present invention provides a controller, including:

at least one processor, and

a memory communicatively connected to the at least one processor, where the memory stores instructions executable by the at least one processor, and the instructions are executed by the at least one processor to enable the at least one processor to perform the returning method described above.

According to a third aspect, an embodiment of the present invention provides an unmanned aerial vehicle, including:

at least two flight modes and the controller described above.

According to a fourth aspect, an embodiment of the present invention provides a non-transitory computer-readable storage medium, storing computer executable instructions, the computer executable instructions being configured to enable an unmanned aerial vehicle to perform the returning method described above.

Compared with the existing technology, the technical solutions of the present invention have the following beneficial effects: a returning method in the present invention is applied to an unmanned aerial vehicle, and the returning method includes: first obtaining a flight mode of the unmanned aerial vehicle, and determining a returning mode of the unmanned aerial vehicle according to the flight mode; and then controlling, according to the returning mode of the unmanned aerial vehicle the unmanned aerial vehicle to return from a current position to a landing point, and switching, in a returning process, the returning mode of the unmanned aerial vehicle in real time according to a flight speed of the unmanned aerial vehicle. Therefore, the returning method combines a plurality of returning modes for returning, and can switch, in the returning process, the returning mode of the unmanned aerial vehicle according to an actual situation of the unmanned aerial vehicle, thereby improving the returning efficiency of the unmanned aerial vehicle, and improving the user experience.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic diagram of an application environment according to an embodiment of the present invention;

FIG. 2 is a schematic diagram of a hardware structure of a controller in an unmanned aerial vehicle shown in FIG. 1;

FIG. 3 is a schematic flowchart of a returning method according to an embodiment of the present invention;

FIG. 4 is a schematic flowchart of step S20 in FIG. 3;

FIG. 5 is a schematic flowchart of step S21 in FIG. 4;

FIG. 6 is a schematic flowchart of step S215 in FIG. 5;

FIG. 7 is a schematic flowchart of step S20 according to another embodiment of the present invention;

FIG. 8 is a schematic flowchart of step S20 according to still another embodiment of the present invention;

FIG. 9 is a schematic flowchart of step S26 in FIG. 8; and

FIG. 10 is a schematic structural diagram of a returning apparatus according to an embodiment of the present invention.

### DETAILED DESCRIPTION

To make the objectives, technical solutions, and advantages of the present invention clearer and more understandable, the present invention is further described in detail below with reference to the accompanying drawings and the embodiments. It should be understood that the specific embodiments described herein are merely used to explain the present invention but are not intended to limit the present invention. All other embodiments obtained by a person of ordinary skill in the art based on the embodiments of the present invention without creative efforts shall fall within the protection scope of the present invention.

It should be noted that, if no conflict occurs, features in the embodiments of the present invention may be combined with each other and fall within the protection scope of the present invention. In addition, although functional module division is performed in the schematic diagram of the apparatus, and a logical sequence is shown in the flowchart, in some cases, the shown or described steps may be performed by using module division different from the module division in the apparatus, or in a sequence different from the sequence in the flowchart. In addition, words such as “first”, “second” and “third” used in the present invention do not limit data or an execution order, but are only used to distinguish same objects or similar objects whose functions and purposes are basically the same.

The embodiments of the present invention provide a returning method and apparatus, applied to an unmanned aerial vehicle. The method and apparatus may first obtain a flight mode of the unmanned aerial vehicle, and determine a returning mode of the unmanned aerial vehicle according to the flight mode, where the flight mode includes a first flight mode and a second flight mode; and then control, according to the returning mode of the unmanned aerial vehicle, the unmanned aerial vehicle to return from a current position to a landing point, and switch, in a returning process, the returning mode of the unmanned aerial vehicle according to a flight speed of the unmanned aerial vehicle. Therefore, the returning method combines a plurality of returning modes for returning, and can switch, in the returning process, the returning mode of the unmanned aerial vehicle according to an actual situation of the unmanned aerial vehicle, thereby improving the returning efficiency of the unmanned aerial vehicle, and improving the user experience.

The returning apparatus may be a virtual apparatus formed by software programs that can implement the returning method provided in the embodiments of the present invention. The returning apparatus and the returning method provided in the embodiments of the present invention are based on the same inventive concept, and have the same technical features and beneficial effects.

The unmanned aerial vehicle may be any type of unmanned aircraft, for example: a fixed-wing unmanned aerial vehicle, a tilt-rotor unmanned aerial vehicle, a rotary-wing unmanned aerial vehicle, a para-wing unmanned aerial vehicle or a flapping-wing unmanned aerial vehicle. Any type of processor may be disposed in the unmanned aerial vehicle, and can perform the returning method provided in the embodiments of the present invention or run the returning apparatus provided in the embodiments of the present invention.

The following describes application environments of the returning method and apparatus by using an example.

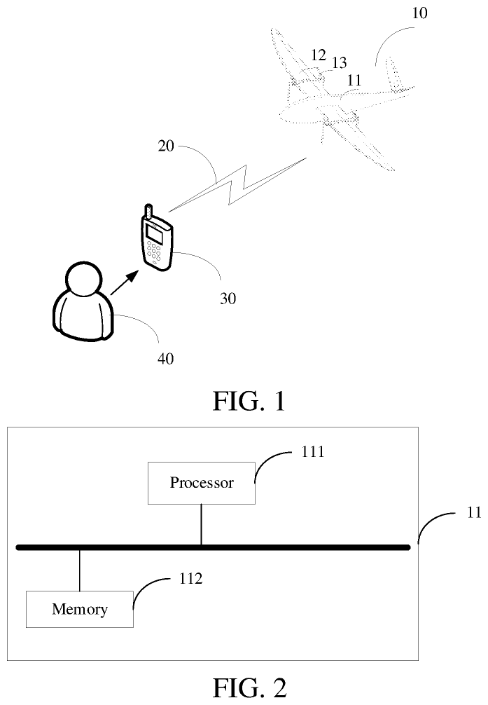

FIG. 1 is a schematic diagram of an application environment of a flight control system according to an embodiment of the present invention. As shown in FIG. 1, the application environment includes an unmanned aerial vehicle 10, a wireless network 20, a smart terminal 30 and a user 40. The user 40 may operate the smart terminal 30 to control the unmanned aerial vehicle 10 through the wireless network 20.

The unmanned aerial vehicle 10 may be any type of power-driven unmanned aerial vehicle, including, but not limited to, a tilt-rotor unmanned aerial vehicle, a fixed-wing unmanned aerial vehicle, a para-wing unmanned aerial vehicle, a flapping-wing unmanned aerial vehicle, a helicopter model and the like. In this embodiment, the tilt-rotor unmanned aerial vehicle is used as an example for description.

The unmanned aerial vehicle 10 may have a corresponding volume or power according to an actual requirement, to provide a load capacity, a flight speed and a flight mileage that can meet a use requirement. One or more functional modules may be further added to the unmanned aerial vehicle 10 to enable the unmanned aerial vehicle 10 to implement corresponding functions.

The unmanned aerial vehicle 10 includes at least one main control chip, which serves as a control core of the unmanned aerial vehicle for flight and data transmission and integrates one or more modules to execute corresponding logic control programs.

For example, in some embodiments, the main control chip may include a returning apparatus 50 configured to select and process a returning mode.

The smart terminal 30 may be any type of smart apparatus configured to establish a communication connection to the unmanned aerial vehicle 10, for example, a mobile phone, a tablet computer or a smart remote control. The smart terminal 30 may be equipped with one or more types of different interaction apparatuses for the user 40 configured to acquire an instruction of the user 40 or present or feed back information to the user 40.

The interaction apparatuses include, but are not limited to, a key, a display screen, a touchscreen, a speaker and a remote control joystick. For example, the smart terminal 30 may be equipped with a touch display screen. Through the touch display screen, a remote control instruction for the unmanned aerial vehicle 10 is received from the user 40, and image information obtained through aerial photography is presented to the user 40. The user 40 may further switch the image information currently displayed on the display screen by remotely controlling the touch screen.

The wireless network 20 may be a wireless communication network configured to establish a data transmission channel between two nodes based on any type of data transmission principle, for example, a Bluetooth network, a Wireless Fidelity (Wi-Fi) network, a wireless cellular network, or a combination thereof located in different signal frequency bands. Alternatively, the wireless network may realize the wireless connection by using a Wi-Fi technology, a Bluetooth technology or a mobile communication technology such as a 3rd Generation (3G) technology, a 4th Generation (4G) technology or a 5th Generation (5G) technology. This is not limited herein.

The unmanned aerial vehicle 10 may be specifically a tilt-rotor unmanned aerial vehicle, which may include a body 11, arms 12 connected to the body 11 and a power apparatus 13 mounted on each of the arms 12. The power apparatus 13 is configured to provide a lift force or power for the unmanned aerial vehicle 10 to fly. For example, as shown in FIG. 2, a controller may be disposed in the body 11 of the unmanned aerial vehicle 10. The controller includes at least one processor 111 (using one processor as an example in FIG. 2) and a memory 112 that are in communication connection through a system bus or another manner. The controller may exist in the form of a chip.

The memory 112 stores instructions executable by the at least one processor 111, the instructions are executed by the at least one processor 111, and the processor 111 is configured to provide a computing and control capability, to control the unmanned aerial vehicle 10 to fly and perform a corresponding task, for example, to control the unmanned aerial vehicle 10 to perform any of the returning methods provided in the embodiments of the present invention.

The memory 112, as a non-transitory computer-readable storage medium, may be configured to store a non-transitory software program, a non-transitory computer executable program and a module, such as a program instruction/module corresponding to the returning method in the embodiments of the present invention. The processor 111 runs the non-transitory software program, the instructions and the module stored in the memory 112, which can implement the returning method in any of the following method embodiments. Specifically, the memory 112 may include a high-speed random access memory, and may further include a non-transitory memory, such as at least one magnetic disk memory device, a flash memory device or other non-transitory solid-state memory devices. In some embodiments, the memory 112 may further include memories remotely disposed relative to the processor 111, and the remote memories may be connected to the processor 111 through a network. Examples of the network include, but are not limited to, the Internet, an intranet, a local area network, a mobile communication network and a combination thereof.

It should be noted that, the above application scenario is only for exemplary description. In actual applications, the returning method and the related apparatus provided in the embodiments of the present invention may be further extended to other suitable application environments, and are not limited to the application environment shown in FIG. 1. For example, in some other embodiments, the unmanned aerial vehicle 10 may also be another type of unmanned aircraft, for example: a single-rotor unmanned aerial vehicle, a hexarotor unmanned aerial vehicle, a quadrotor unmanned aerial vehicle, a para-wing unmanned aerial vehicle or a flapping-wing unmanned aerial vehicle. There may also be more than one unmanned aerial vehicle 10 and more than one smart terminal 30.

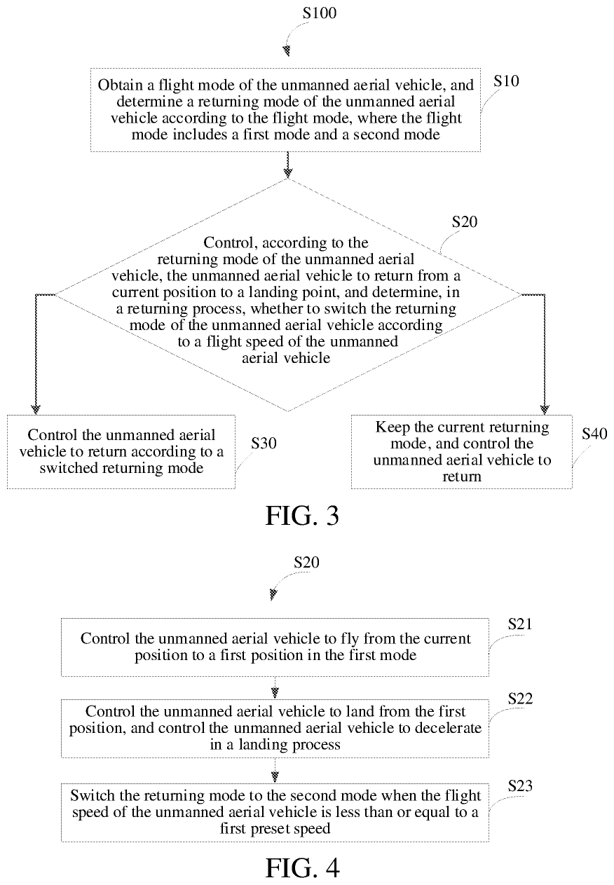

Referring to FIG. 3, FIG. 3 is a schematic flowchart of a returning method according to an embodiment of the present invention. As shown in FIG. 3, the returning method S100 includes the following steps:

S10. Obtain a flight mode of an unmanned aerial vehicle, and determine a returning mode of the unmanned aerial vehicle according to the flight mode.

The unmanned aerial vehicle includes a plurality of flight modes, and different flight modes are selected according to different actual situations. The flight modes include, but are not limited to, a first flight mode and a second flight mode. The first flight mode may be a fixed-wing mode characterized by low power consumption, in which the unmanned aerial vehicle may fly in a circling manner. The second flight mode may be a rotary-wing mode characterized by high power consumption, in which the unmanned aerial vehicle can vertically take off or land and can hover. When the unmanned aerial vehicle is in a returning phase, a current flight mode of the unmanned aerial vehicle is first determined, and then a returning mode of the unmanned aerial vehicle is determined according to the flight mode. If the flight mode is the fixed-wing mode, the returning mode of the unmanned aerial vehicle is determined as the fixed-wing mode. If the flight mode is the rotary-wing mode, the returning mode of the unmanned aerial vehicle is determined as the rotary-wing mode.

S20. Control, according to the returning mode of the unmanned aerial vehicle, the unmanned aerial vehicle to return from a current position to a landing point, and determine, in a returning process, whether to switch the returning mode of the unmanned aerial vehicle according to a flight speed of the unmanned aerial vehicle.

In different returning modes, flight speeds suitable for the unmanned aerial vehicle are different. For example, a flight speed suitable for the rotary-wing mode ranges from 0 to 8 m/s, a flight speed suitable for the fixed-wing mode ranges from 15 to 30 m/s, and a flight speed suitable for a switching mode between the two modes ranges from 8 m/s to 15 m/s. In addition, in the returning process of the unmanned aerial vehicle, the unmanned aerial vehicle may return from the current position to the landing point at an acceleration, a deceleration or a constant speed. Therefore, the flight speed of the unmanned aerial vehicle changes, and a returning mode suitable for a current flight speed is switched in real time according to the flight speed of the unmanned aerial vehicle.

S30. Control, when it is determined to switch the returning mode of the unmanned aerial vehicle, the unmanned aerial vehicle to return according to a switched returning mode.

S40. Keep the current returning mode when it is determined not to switch the returning mode of the unmanned aerial vehicle, and control the unmanned aerial vehicle to return.

When it is determined to switch the returning mode, the unmanned aerial vehicle is controlled to return according to the switched returning mode. In addition, in the returning process, it is still determined whether to switch the returning mode used at the current flight speed according to the flight speed of the unmanned aerial vehicle.

Therefore, the returning method can combine, in the returning process, a plurality of returning modes for returning, and can switch, in the returning process, the returning mode of the unmanned aerial vehicle according to an actual flight speed of the unmanned aerial vehicle, thereby improving the returning efficiency of the unmanned aerial vehicle, and improving the user experience.

In some embodiments, the unmanned aerial vehicle includes a plurality of returning modes, including, but not limited to, a first mode and a second mode. In this embodiment of the present invention, the returning mode includes the first mode and the second mode, and when the returning mode of the unmanned aerial vehicle is the first mode, referring to FIG. 4, step S20 includes the following step:

S21. Control the unmanned aerial vehicle to fly from the current position to a first position in the first mode.

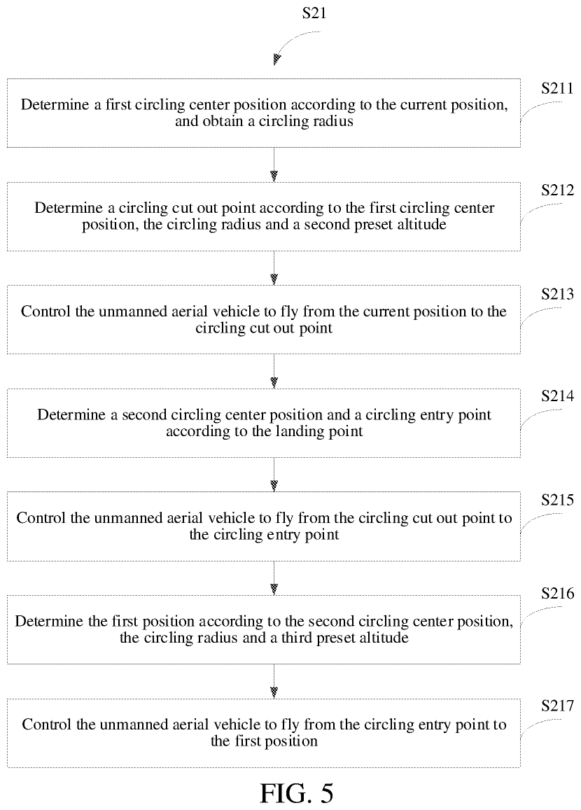

In this embodiment of the present invention, referring to FIG. 5, step S21 includes the following steps:

S211. Determine a first circling center position according to the current position, and obtain a circling radius.

When the unmanned aerial vehicle returns in the first mode, the first circling center position is determined through the current position of the unmanned aerial vehicle, and the circling radius is determined through motion performance of the unmanned aerial vehicle.

S212. Determine a circling cut out point according to the first circling center position, the circling radius and a second preset altitude.

S213. Control the unmanned aerial vehicle to fly from the current position to the circling cut out point.

The circling cut out point is a position where the unmanned aerial vehicle cuts out a first circling point. When the unmanned aerial vehicle flies from the current position to the circling cut out point, the unmanned aerial vehicle first rises from the current position to a second preset altitude h1 in a circling manner with the first circling center position as a center and the circling radius as a radius, and then stops circling and cuts out from the circling cut out point.

S214. Determine a second circling center position and a circling entry point according to the landing point.

The circling entry point is a position where the unmanned aerial vehicle enters a second circling point. A position of a center of the second circling point is determined by the landing point, and a circling radius is also determined by the motion performance of the aircraft. Therefore, the circling radius of the first circling point is the same as the circling radius of the second circling point.

S215. Control the unmanned aerial vehicle to fly from the circling cut out point to the circling entry point.

S216. Determine the first position according to the second circling center position, the circling radius and a third preset altitude.

S217. Control the unmanned aerial vehicle to fly from the circling entry point to the first position.

After the unmanned aerial vehicle flies from the circling cut out point of the first circling point, the unmanned aerial vehicle flies to the circling entry point of the second circling point, and then rises in a circling manner with the second circling center position as a center and the circling radius as a radius. An altitude that the unmanned aerial vehicle risen by in the circling manner is a third preset altitude h2. After rising by the third preset altitude h2, the unmanned aerial vehicle reaches the first position, and stops circling. Therefore, the first position is a position at a circle with the second circling center position as the center and the circling radius as the radius after the unmanned aerial vehicle rises by the third preset altitude.

The unmanned aerial vehicle reaches the first position from the current position in the circling manner Compared with a manner of directly flying from the current position to the first position, more space is saved, and required distance and range are smaller.

S22. Control the unmanned aerial vehicle to land from the first position, and control the unmanned aerial vehicle to decelerate in a landing process.

S23. Switch the returning mode to the second mode when the flight speed of the unmanned aerial vehicle is less than or equal to a first preset speed.

In the process of controlling the unmanned aerial vehicle to land from the first position, a braking distance is calculated in real time according to the current flight speed of the unmanned aerial vehicle; when the braking distance is less than or equal to a distance of the first position from the landing point, the unmanned aerial vehicle is controlled to decelerate, and the flight speed of the unmanned aerial vehicle is also obtained in real time; and when the flight speed decreases to below the first preset speed, the returning mode of the unmanned aerial vehicle is switched. If the first mode is the fixed-wing mode, the first preset speed may be 8 m/s, and may also be set according to user requirements.

In the process in which the unmanned aerial vehicle flies from the first position to the landing point in the first mode, when the flight speed of the unmanned aerial vehicle decreases to below the first preset speed, the returning mode of the unmanned aerial vehicle is switched to the second mode, to enable the unmanned aerial vehicle to continue to return in the second mode. Therefore, the returning method enables the unmanned aerial vehicle to combine a plurality of returning modes, and realizes switching of a returning mode according to an actual flight speed.

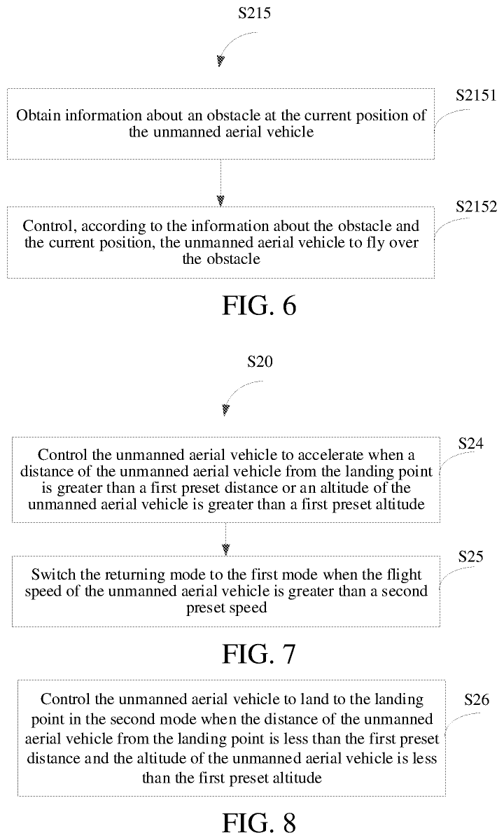

In some embodiments, in the process of flying from the circling cut out point to the circling entry point, the unmanned aerial vehicle may encounter an obstacle. Therefore, in the flying process, an obstacle avoidance operation needs to be performed. Referring to FIG. 6, step S215 includes the following steps:

S2151. Obtain information about an obstacle at the current position of the unmanned aerial vehicle.

The information about the obstacle may be obtained from elevation data of the unmanned aerial vehicle, and the information about the obstacle includes an altitude of the obstacle. Specifically, through latitude and longitude coordinates of the current position of the unmanned aerial vehicle, an altitude of a terrain at the current latitude and longitude coordinates may be obtained. Generally, elevation data of hills and mountains is more obvious. Then, a first altitude is determined according to the altitude of the obstacle, where the first altitude is higher than the altitude of the obstacle, and a specific value of the first altitude may be set according to user requirements.

S2152. Control, according to the information about the obstacle and the current position, the unmanned aerial vehicle to fly over the obstacle.

After the first altitude is determined, the unmanned aerial vehicle is controlled to fly from the current position to the first altitude, but a specific position where the unmanned aerial vehicle reaches is not limited as long as the altitude reaches the first altitude; and then the unmanned aerial vehicle is controlled to keep flying at the first altitude, to cause the unmanned aerial vehicle to fly over the obstacle. Therefore, by keeping flying at an altitude higher than the altitude of the obstacle, the unmanned aerial vehicle can better avoid the obstacle. In addition, the information about the obstacle is directly obtained through the elevation data, and a situation of a position where the obstacle is located is obtained according to a map plan, without an additional sensor to measure the obstacle, which is more convenient and fast.

When the returning mode of the unmanned aerial vehicle is the second mode, referring to FIG. 7, step S20 includes the following steps:

S24. Control the unmanned aerial vehicle to accelerate when a distance of the unmanned aerial vehicle from the landing point is greater than a first preset distance or an altitude of the unmanned aerial vehicle is greater than a first preset altitude.

S25. Switch the returning mode to the first mode when the flight speed of the unmanned aerial vehicle is greater than a second preset speed.

In the process in which the unmanned aerial vehicle returns in the second mode, a distance S of the current position of the unmanned aerial vehicle from the landing point and an altitude h of the current position of the unmanned aerial vehicle are obtained in real time. If S is greater than a first preset distance 51 or h is greater than a first preset altitude h3, it indicates that the unmanned aerial vehicle is currently farther from the landing point, or the unmanned aerial vehicle needs a longer distance to reach the landing point. Therefore, the unmanned aerial vehicle is controlled to accelerate for flying, and the flight speed of the unmanned aerial vehicle is obtained in real time. When the flight speed of the unmanned aerial vehicle is greater than the second preset speed, the returning mode of the unmanned aerial vehicle is switched to the first mode. If the second mode is the rotary-wing mode, the second preset speed is 15 m/s, and may also be set according to user requirements.

In some embodiments, when the unmanned aerial vehicle returns in the second mode, referring to FIG. 8, step S20 further includes the following step:

S26. Control the unmanned aerial vehicle to land to the landing point in the second mode when the distance of the unmanned aerial vehicle from the landing point is less than the first preset distance and the altitude of the unmanned aerial vehicle is less than the first preset altitude.

The distance S of the current position of the unmanned aerial vehicle from the landing point and the altitude h of the current position of the unmanned aerial vehicle are obtained in real time. If the distance S is less than the first preset distance 51 and h is less than the first preset altitude h3, it indicates that the unmanned aerial vehicle is currently closer to the landing point. Therefore, the unmanned aerial vehicle flies at a lower speed, and does not reach a speed at which the returning mode can be switched, so as to continue to control the unmanned aerial vehicle to land to the landing point in the second mode.

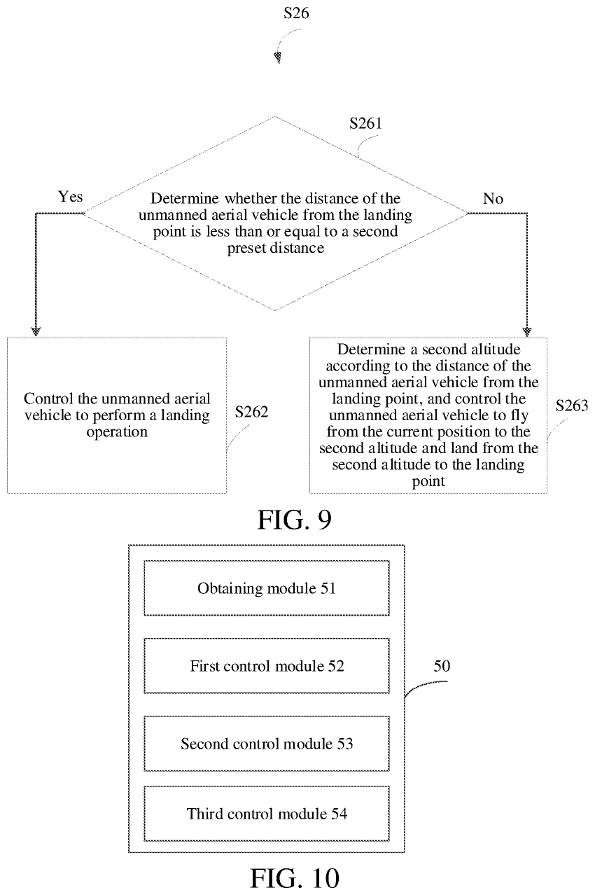

In some embodiments, in the process of controlling the unmanned aerial vehicle to land to the landing point in the second mode, a corresponding returning operation also needs to be performed according to the distance of the unmanned aerial vehicle from the landing point. Specifically, referring to FIG. 9, step S26 includes the following steps:

S261. Determine whether the distance of the unmanned aerial vehicle from the landing point is less than or equal to a second preset distance.

S262. Control, when the distance of the unmanned aerial vehicle from the landing point is less than or equal to the second preset distance, the unmanned aerial vehicle to perform a landing operation.

S263. Determine, when the distance of the unmanned aerial vehicle from the landing point is greater than the second preset distance, a second altitude according to the distance of the unmanned aerial vehicle from the landing point, and control the unmanned aerial vehicle to fly from the current position to the second altitude and land from the second altitude to the landing point.

If the distance of the unmanned aerial vehicle from the landing point meets being less than or equal to the second preset distance, it indicates that the unmanned aerial vehicle is very close to the landing point. Therefore, the unmanned aerial vehicle is controlled to perform the landing operation. Specifically, the landing operation refers to controlling the unmanned aerial vehicle to vertically land from the current position. If the distance of the unmanned aerial vehicle from the landing point does not meet being less than or equal to the second preset distance, it indicates that the unmanned aerial vehicle is still a specific distance from the landing point. Therefore, the unmanned aerial vehicle is controlled to rise from the current position to the second altitude and then land from the second altitude to the landing point. Because the unmanned aerial vehicle straightly flies in the landing process, landing to the landing point after rising by a specific altitude can filter out some obstacles between the current position and the landing point, thereby realizing obstacle avoidance. In addition, in the landing process, when the unmanned aerial vehicle is controlled to straightly fly to the landing point, the speed and the operation corresponding to the speed are adjusted in real time according to the distance of the unmanned aerial vehicle from the landing point. Once the distance of the unmanned aerial vehicle from the landing point is less than or equal to the second preset distance, the unmanned aerial vehicle is controlled to vertically land from the current position.

To better describe this embodiment, an operation procedure of this embodiment of the present invention is illustrated below with reference to a specific example: assuming that the first preset distance is 300 m, the second preset distance is 3 m, the first preset altitude is 50 m, the second altitude may be 5 m or 50 m, the first preset speed is 8 m/s and the second preset speed is 15 m/s, when the returning mode of the unmanned aerial vehicle is the second mode, if the distance S of the unmanned aerial vehicle from the landing point is greater than 300 m or the altitude of the unmanned aerial vehicle is greater than 50 m, the unmanned aerial vehicle is controlled to accelerate, and the returning mode is switched to the first mode if a flight speed V of the unmanned aerial vehicle is greater than 15 m/s in the acceleration process. If the distance S of the unmanned aerial vehicle from the landing point is less than 300 m or the altitude of the unmanned aerial vehicle is less than 50 m, it is determined whether the distance S of the unmanned aerial vehicle from the landing point is less than or equal to 3 m; if the distance S of the unmanned aerial vehicle from the landing point is less than or equal to 3 m, the unmanned aerial vehicle is controlled to vertically land from the current position; and if the distance S of the unmanned aerial vehicle from the landing point is not less than or not equal to 3 m, the second altitude is determined according to the distance S of the unmanned aerial vehicle from the landing point, and the unmanned aerial vehicle is controlled to fly from the current position to the second altitude and land from the second altitude to the landing point. Specifically, if the distance S of the unmanned aerial vehicle from the landing point ranges from 3 to 20 m, the unmanned aerial vehicle rises from the current position to an altitude of 5 m and lands from the altitude of 5 m to the landing point; if an original altitude of the unmanned aerial vehicle has exceeded 5 m, the unmanned aerial vehicle directly and straightly flies from the current altitude to the landing point; and if the distance S of the unmanned aerial vehicle from the landing point ranges from 20 to 300 m, the unmanned aerial vehicle rises from the current position to an altitude of 50 m and straightly flies and lands from the altitude of 50 m to the landing point.

In summary, the returning method can combine different returning modes for returning, and switch, by adopting an actual flight speed as a switching condition in a returning process, a returning mode according to an actual flight situation of an unmanned aerial vehicle. Therefore, the returning method improves the returning efficiency of the unmanned aerial vehicle, and improves the user experience.

FIG. 10 is a schematic structural diagram of a returning apparatus according to an embodiment of the present invention. A returning apparatus 50 includes an obtaining module 51, configured to obtain a flight mode of the unmanned aerial vehicle, and determine a returning mode of the unmanned aerial vehicle according to the flight mode, where the flight mode includes a first mode and a second mode; a first control module 52, configured to control the unmanned aerial vehicle to return from a current position to a landing point according to the returning mode of the unmanned aerial vehicle, and determine, in a returning process, whether to switch the returning mode of the unmanned aerial vehicle according to a flight speed of the unmanned aerial vehicle; a second control module 53, configured to control the unmanned aerial vehicle to return according to a switched returning mode; and a third control module 54, configured to keep the current returning mode, and control the unmanned aerial vehicle to return.

Therefore, in this embodiment, a flight mode of an unmanned aerial vehicle is first obtained, and a returning mode of the unmanned aerial vehicle is determined according to the flight mode; the unmanned aerial vehicle is controlled to return from a current position to a landing point according to the returning mode of the unmanned aerial vehicle, and in a returning process, it is determined whether to switch the returning mode of the unmanned aerial vehicle according to a flight speed of the unmanned aerial vehicle; when it is determined to switch the returning mode of the unmanned aerial vehicle, the unmanned aerial vehicle is controlled to return according to a switched returning mode; and when it is determined not to switch the returning mode of the unmanned aerial vehicle, the current returning mode is kept and the unmanned aerial vehicle is controlled to return. Therefore, the returning method combines a plurality of returning modes for returning, and can switch, in the returning process, the returning mode of the unmanned aerial vehicle according to an actual situation of the unmanned aerial vehicle, thereby improving the returning efficiency of the unmanned aerial vehicle, and improving the user experience.

In some embodiments, the returning mode includes a first mode and a second mode, and when the returning mode of the unmanned aerial vehicle is the first mode, the first control module 52 includes a first control unit, configured to control the unmanned aerial vehicle to fly from the current position to a first position in the first mode; a second control unit, configured to control the unmanned aerial vehicle to land from the first position, and controlling the unmanned aerial vehicle to decelerate in a landing process; and a first switching unit, configured to switch the returning mode to the second mode when the flight speed of the unmanned aerial vehicle is less than or equal to a first preset speed.

In some embodiments, the first control unit is further configured to determine a first circling center position according to the current position, and obtain a circling radius; determine a circling cut out point according to the first circling center position, the circling radius and a second preset altitude; control the unmanned aerial vehicle to fly from the current position to the circling cut out point; determine a second circling center position and a circling entry point according to the landing point; control the unmanned aerial vehicle to fly from the circling cut out point to the circling entry point; determine the first position according to the second circling center position, the circling radius and a third preset altitude; and control the unmanned aerial vehicle to fly from the circling entry point to the first position.

In some embodiments, the first control unit further includes an obtaining subunit, configured to obtain information about an obstacle at the current position of the unmanned aerial vehicle; and a first control subunit, configured to control, according to the information about the obstacle and the current position, the unmanned aerial vehicle to fly over the obstacle.

In some embodiments, the information about the obstacle includes an altitude obstacle, and the first control subunit is further configured to determine a first altitude according to the altitude of the obstacle, where the first altitude is higher than the altitude of the obstacle; control the unmanned aerial vehicle to fly from the current position to the first altitude; and control the unmanned aerial vehicle to keep flying at the first altitude, to cause the unmanned aerial vehicle to fly over the obstacle.

In some embodiments, when the returning mode of the unmanned aerial vehicle is the second mode, the first control module 52 includes a third control unit, configured to control the unmanned aerial vehicle to accelerate when a distance of the unmanned aerial vehicle from the landing point is greater than a first preset distance or an altitude of the unmanned aerial vehicle is greater than a first preset altitude; and a second switching unit, configured to switch the returning mode to the first mode when the flight speed of the unmanned aerial vehicle is greater than a second preset speed.

In some embodiments, the second switching unit includes a second control subunit, configured to control the unmanned aerial vehicle to land to the landing point in the second mode when the distance of the unmanned aerial vehicle from the landing point is less than the first preset distance and the altitude of the unmanned aerial vehicle is less than the first preset altitude.

In some embodiments, the second control subunit is further configured to determine whether the distance of the unmanned aerial vehicle from the landing point is less than or equal to a second preset distance; control, when the distance of the unmanned aerial vehicle from the landing point is less than or equal to the second preset distance, the unmanned aerial vehicle to perform a landing operation; and determine, when the distance of the unmanned aerial vehicle from the landing point is not less than or not equal to the second preset distance, a second altitude according to the distance of the unmanned aerial vehicle from the landing point, and control the unmanned aerial vehicle to fly from the current position to the second altitude and land from the second altitude to the landing point.

It should be noted that, because the returning apparatus and the returning method described in the foregoing embodiments are based on the same inventive concept, the corresponding content in the foregoing method embodiments is also applicable to this apparatus embodiment, and details are not described herein again.

Therefore, the returning apparatus may obtain, by an obtaining module 51, a flight mode of an unmanned aerial vehicle, and determine a returning mode of the unmanned aerial vehicle according to the flight mode; control, by a first control module 52 according to the returning mode of the unmanned aerial vehicle, the unmanned aerial vehicle to return from a current position to a landing point, and determine, in a returning process, whether to switch the returning mode of the unmanned aerial vehicle according to a flight speed of the unmanned aerial vehicle; control, when it is determined to switch the returning mode of the unmanned aerial vehicle, the unmanned aerial vehicle to return according to a switched returning mode; and keep the current returning mode when it is determined not to switch the returning mode of the unmanned aerial vehicle, and control the unmanned aerial vehicle to return. Therefore, the returning apparatus combines a plurality of returning modes for returning, and can switch, in the returning process, the returning mode of the unmanned aerial vehicle according to an actual situation of the unmanned aerial vehicle, thereby improving the returning efficiency of the unmanned aerial vehicle, and improving the user experience.

An embodiment of the present invention further provides a non-volatile computer-readable storage medium, storing computer executable instructions. The computer executable instructions are executed by one or more processors, for example, one processor 111 in FIG. 2, so that the above one or more processors may perform the returning method in any of the above method embodiments.

An embodiment of the present invention further provides a computer program product, including a computer program stored in a non-volatile computer-readable storage medium, the computer program including program instructions, the program instructions, when executed by a controller, causing the controller to perform the returning method in any of the descriptions.

Based on the descriptions of the foregoing implementations, a person of ordinary skill in the art may clearly understand that the implementations may be implemented by software in addition to a universal hardware platform, or by hardware. A person of ordinary skill in the art may understand that all or some of procedures in the foregoing embodiment methods may be implemented by a computer program in a computer program product instructing relevant hardware. The computer program may be stored in a non-transitory computer-readable storage medium, and the computer program includes program instructions. When the program instructions are executed by an unmanned aerial vehicle, the unmanned aerial vehicle may be enabled to execute the procedures of the foregoing method embodiments The storage medium may be a magnetic disk, an optical disc, a read-only memory (ROM), a RAM or the like.

The returning method combines a plurality of returning modes for returning, and can switch, in the returning process, the returning mode of the unmanned aerial vehicle according to an actual situation of the unmanned aerial vehicle, thereby improving the returning efficiency of the unmanned aerial vehicle, and improving the user experience.

Finally, it should be noted that the foregoing embodiments are merely used for describing the technical solutions of the present invention, but are not intended to limit the present invention. Under the ideas of the present invention, the technical features in the foregoing embodiments or different embodiments may also be combined, the steps may be performed in any order, and many other changes of different aspects of the present invention also exists as described above, and these changes are not provided in detail for simplicity. It should be understood by a person of ordinary skill in the art that although the present invention has been described in detail with reference to the foregoing embodiments, modifications can be made to the technical solutions described in the foregoing embodiments, or equivalent replacements can be made to some technical features in the technical solutions, without departing from the scope of the technical solutions of the embodiments of the present application.

What is claimed is:

1. A returning method, applied to an unmanned aerial vehicle, comprising at least two returning modes, the method comprising:
obtaining a flight mode of the unmanned aerial vehicle, and determining a returning mode of the unmanned aerial vehicle according to the flight mode; and
controlling, according to the returning mode of the unmanned aerial vehicle, the unmanned aerial vehicle to return from a current position to a landing point; and
switching, in a returning process, the returning mode of the unmanned aerial vehicle in real time according to a flight speed of the unmanned aerial vehicle.

2. The method according to claim 1, wherein the returning mode comprises a first mode and a second mode, and when the returning mode of the unmanned aerial vehicle is the first mode, the controlling, according to the returning mode of the unmanned aerial vehicle, the unmanned aerial vehicle to return from a current position to a landing point, and switching, in a returning process, the returning mode of the unmanned aerial vehicle in real time according to a flight speed of the unmanned aerial vehicle comprises:
controlling the unmanned aerial vehicle to fly from the current position to a first position in the first mode;
controlling the unmanned aerial vehicle to land from the first position, and controlling the unmanned aerial vehicle to decelerate in a landing process; and
switching the returning mode to the second mode when the flight speed of the unmanned aerial vehicle is less than or equal to a first preset speed.

3. The method according to claim 2, wherein when the returning mode of the unmanned aerial vehicle is the second mode, the controlling, according to the returning mode of the unmanned aerial vehicle, the unmanned aerial vehicle to return from a current position to a landing point, and switching, in a returning process, the returning mode of the unmanned aerial vehicle in real time according to a flight speed of the unmanned aerial vehicle comprises:
controlling the unmanned aerial vehicle to accelerate when a distance of the unmanned aerial vehicle from the landing point is greater than a first preset distance or an altitude of the unmanned aerial vehicle is greater than a first preset altitude; and
switching the returning mode to the first mode when the flight speed of the unmanned aerial vehicle is greater than a second preset speed.

4. The method according to claim 2, wherein the controlling the unmanned aerial vehicle to fly from the current position to a first position in the first mode comprises:
determining a first circling center position according to the current position, and obtaining a circling radius;
determining a circling cut out point according to the first circling center position, the circling radius and a second preset altitude;
controlling the unmanned aerial vehicle to fly from the current position to the circling cut out point;
determining a second circling center position and a circling entry point according to the landing point;
controlling the unmanned aerial vehicle to fly from the circling cut out point to the circling entry point;
determining the first position according to the second circling center position, the circling radius and a third preset altitude; and
controlling the unmanned aerial vehicle to fly from the circling entry point to the first position.

5. The method according to claim 4, wherein the controlling the unmanned aerial vehicle to fly from the circling cut out point to the circling entry point comprises:
obtaining information about an obstacle at the current position of the unmanned aerial vehicle; and
controlling, according to the information about the obstacle and the current position, the unmanned aerial vehicle to fly over the obstacle.

6. The method according to claim 5, wherein the information about the obstacle comprises an altitude of the obstacle, and the controlling, according to the information about the obstacle and the current position of the unmanned aerial vehicle, the unmanned aerial vehicle to fly over the obstacle comprises:
determining a first altitude according to the altitude of the obstacle, wherein the first altitude is higher than the altitude of the obstacle;
controlling the unmanned aerial vehicle to fly from the current position to the first altitude; and
controlling the unmanned aerial vehicle to keep flying at the first altitude, to cause the unmanned aerial vehicle to fly over the obstacle.

7. The method according to claim 3, wherein the controlling, according to the returning mode of the unmanned aerial vehicle, the unmanned aerial vehicle to return from a current position to a landing point, and determining, in a returning process, switch the returning mode of the unmanned aerial vehicle in real time according to a flight speed of the unmanned aerial vehicle further comprises:
controlling the unmanned aerial vehicle to land to the landing point in the second mode when the distance of the unmanned aerial vehicle from the landing point is less than the first preset distance and the altitude of the unmanned aerial vehicle is less than the first preset altitude.

8. The method according to claim 7, wherein the controlling the unmanned aerial vehicle to land to the landing point in the second mode comprises:
determining whether the distance of the unmanned aerial vehicle from the landing point is less than or equal to a second preset distance;
controlling, when the distance of the unmanned aerial vehicle from the landing point is less than or equal to the second preset distance, the unmanned aerial vehicle to perform a landing operation; and
determining, when the distance of the unmanned aerial vehicle from the landing point is greater than the second preset distance, a second altitude according to the distance of the unmanned aerial vehicle from the landing point, and controlling the unmanned aerial vehicle to fly from the current position to the second altitude and land from the second altitude to the landing point.

9. A controller, applied to an unmanned aerial vehicle, comprising at least two returning modes, the controller comprising:
at least one processor; and
a memory communicatively connected to the at least one processor, wherein
the memory stores instructions executable by the at least one processor, and the instructions are executed by the at least one processor to enable the at least one processor to perform the following steps:
obtaining a flight mode of the unmanned aerial vehicle, and determining a returning mode of the unmanned aerial vehicle according to the flight mode; and
controlling, according to the returning mode of the unmanned aerial vehicle, the unmanned aerial vehicle to return from a current position to a landing point; and
switching, in a returning process, the returning mode of the unmanned aerial vehicle in real time according to a flight speed of the unmanned aerial vehicle.

10. The controller according to claim 9, wherein the returning mode comprises a first mode and a second mode, and when the returning mode of the unmanned aerial vehicle is the first mode, the at least one processor performs the following steps:
controlling the unmanned aerial vehicle to fly from the current position to a first position in the first mode;
controlling the unmanned aerial vehicle to land from the first position, and controlling the unmanned aerial vehicle to decelerate in a landing process; and
switching the returning mode to the second mode when the flight speed of the unmanned aerial vehicle is less than or equal to a first preset speed.

11. The controller according to claim 10, wherein when the returning mode of the unmanned aerial vehicle is the second mode, the at least one processor performs the following steps:
controlling the unmanned aerial vehicle to accelerate when a distance of the unmanned aerial vehicle from the landing point is greater than a first preset distance or an altitude of the unmanned aerial vehicle is greater than a first preset altitude; and
switching the returning mode to the first mode when the flight speed of the unmanned aerial vehicle is greater than a second preset speed.

12. The controller according to claim 10, wherein the at least one processor performs the following steps:
determining a first circling center position according to the current position, and obtaining a circling radius;
determining a circling cut out point according to the first circling center position, the circling radius and a second preset altitude;
controlling the unmanned aerial vehicle to fly from the current position to the circling cut out point;
determining a second circling center position and a circling entry point according to the landing point;
controlling the unmanned aerial vehicle to fly from the circling cut out point to the circling entry point;
determining the first position according to the second circling center position, the circling radius and a third preset altitude; and
controlling the unmanned aerial vehicle to fly from the circling entry point to the first position.

13. The controller according to claim 12, wherein the at least one processor performs the following steps:
obtaining information about an obstacle at the current position of the unmanned aerial vehicle; and
controlling, according to the information about the obstacle and the current position, the unmanned aerial vehicle to fly over the obstacle.

14. The controller according to claim 13, wherein the information about the obstacle comprises an altitude of the obstacle, and the at least one processor performs the following steps:
determining a first altitude according to the altitude of the obstacle, wherein the first altitude is higher than the altitude of the obstacle;
controlling the unmanned aerial vehicle to fly from the current position to the first altitude; and
controlling the unmanned aerial vehicle to keep flying at the first altitude, to cause the unmanned aerial vehicle to fly over the obstacle.

15. The controller according to claim 11, wherein the at least one processor performs the following step:
controlling the unmanned aerial vehicle to land to the landing point in the second mode when the distance of the unmanned aerial vehicle from the landing point is less than the first preset distance and the altitude of the unmanned aerial vehicle is less than the first preset altitude.

16. The controller according to claim 12, wherein the at least one processor performs the following steps:
determining whether the distance of the unmanned aerial vehicle from the landing point is less than or equal to a second preset distance;
controlling, when the distance of the unmanned aerial vehicle from the landing point is less than or equal to the second preset distance, the unmanned aerial vehicle to perform a landing operation; and
determining, when the distance of the unmanned aerial vehicle from the landing point is greater than the second preset distance, a second altitude according to the distance of the unmanned aerial vehicle from the landing point, and controlling the unmanned aerial vehicle to fly from the current position to the second altitude and land from the second altitude to the landing point.

17. An unmanned aerial vehicle, comprising a controller and at least two returning modes, the controller comprising:
at least one processor; and
a memory communicatively connected to the at least one processor, wherein
the memory stores instructions executable by the at least one processor, and the instructions are executed by the at least one processor to enable the at least one processor to perform the following steps:
obtaining a flight mode of the unmanned aerial vehicle, and determining a returning mode of the unmanned aerial vehicle according to the flight mode; and
controlling, according to the returning mode of the unmanned aerial vehicle, the unmanned aerial vehicle to return from a current position to a landing point; and
switching, in a returning process, the returning mode of the unmanned aerial vehicle in real time according to a flight speed of the unmanned aerial vehicle.

18. The unmanned aerial vehicle according to claim 17, wherein the returning mode comprises a first mode and a second mode, and when the returning mode of the unmanned aerial vehicle is the first mode, the at least one processor performs the following steps:
controlling the unmanned aerial vehicle to fly from the current position to a first position in the first mode;
controlling the unmanned aerial vehicle to land from the first position, and controlling the unmanned aerial vehicle to decelerate in a landing process; and
switching the returning mode to the second mode when the flight speed of the unmanned aerial vehicle is less than or equal to a first preset speed.

19. The unmanned aerial vehicle according to claim 18, wherein when the returning mode of the unmanned aerial vehicle is the second mode, the at least one processor performs the following steps:
controlling the unmanned aerial vehicle to accelerate when a distance of the unmanned aerial vehicle from the landing point is greater than a first preset distance or an altitude of the unmanned aerial vehicle is greater than a first preset altitude; and
switching the returning mode to the first mode when the flight speed of the unmanned aerial vehicle is greater than a second preset speed.

20. The unmanned aerial vehicle according to claim 18, wherein the at least one processor performs the following steps:
determining a first circling center position according to the current position, and obtaining a circling radius;
determining a circling cut out point according to the first circling center position, the circling radius and a second preset altitude;
controlling the unmanned aerial vehicle to fly from the current position to the circling cut out point;
determining a second circling center position and a circling entry point according to the landing point;
controlling the unmanned aerial vehicle to fly from the circling cut out point to the circling entry point;
determining the first position according to the second circling center position, the circling radius and a third preset altitude; and
controlling the unmanned aerial vehicle to fly from the circling entry point to the first position.
